(19) United States
(12) Patent Application Publication
(10) Pub. No.: US 2012/0081891 A1
(43) Pub. Date: Apr. 5, 2012

(54) Structure of light tube

(75) Inventors: I-Hsin Tung, Shulin City (TW); Chiy-Ferng Perng, Shulin City (TW); Chia-Hao Hsieh, Shulin City (TW); Che-Min Chien, Shulin City (TW); Che-Wei Chang, Shulin City (TW)

(73) Assignee: LIGITEK ELECTRONICS CO., LTD., Taipei County (TW)

(21) Appl. No.: 12/923,627

(22) Filed: Sep. 30, 2010

(51) Int. Cl. F21V 29/00

(52) U.S. Cl. 362/218

(57) ABSTRACT

A structure of light tube includes a main body, a power supply module, and at least one light emission element. The main body has first and second heat dissipation zones and an accommodation chamber. The main body has two ends respectively and electrically connected to two conductive terminals. The power supply module is received and retained in the accommodation chamber of the main body. The power supply module includes an enclosure forming a receiving space in which a power supply device is received and retained. The light emission element is coupled to the main body so that heat from the light emission element is directly drained through the main body, while the power supply dissipates heat through natural air flows without relying on the main body, so that there parts do not cause thermal interference with each other and the performance of heat dissipation is improved to thereby extend the lifespan of the light tube. Further, the light emission element and the power supply are of modularized arrangements, which allow the users to conduct maintenance and repairing operation with simple tools by themselves.

### FIELD OF THE INVENTION

The present invention relates to a structure of light tube, and in particular to a structure of light tube that allows for easy replacement of power supply module.

### BACKGROUND OF THE INVENTION

Light-emitting diode contained products are prevailing. Almost every industry provides designs that use light-emitting diode(s), among which lighting devices are most commonly operated with light-emitting diodes. The development of light-emitting diode based light tube is now getting mature. However, further improvement may be needed for heat dissipation. The state-of-the-art designs often arrange a light source and a power supply to be both fixed to a heat dissipater. When put into operation, both the light source and the light supply generate heat, which must be drained through the heat dissipater. This causes a severe problem that the heat dissipater is not efficient enough to drain the heat from both parts, eventually leading to damage to either one of the light source or the power supply. Any damage occurring on either one of the light source and the power supply will require complete disposal of the light-emitting diode based light tube. This is a waste and is not environmentally friendly.

On the other hand, do-it-yourselves (DIY) fashion is prevailing recently. People no longer hire or reply on specialists to handle daily affairs and instead, they do it by themselves with proper tools and parts/materials. For example, people are now used to repairing and maintaining automobiles and electrical appliances by themselves. One goal of this is to create leisure and creational activity and exploits personal creation and habits. The other goal is economic purpose for reducing expenses required in doing the maintenance and repairing.

Thus, it is the purpose of the present invention to provide a structure of light tube that improves the performance of heat dissipation and extension of lifespan and also allows for easy replacement by the users themselves when the light tube is broken or malfunctioning.

### SUMMARY OF THE INVENTION

An objective of the present invention is to provide a structure of light tube, which comprises modularized arrangements of light emission element and power supply so that users are allowed to conduct maintenance and repairing operation by themselves with simple tools.

Another objective of the present invention is to provide a structure of light tube, in which light emission element and power supply are arranged at different locations, whereby heat from the light emission element is directly drained through the main body, while the power supply dissipates heat through natural air flows without relying on the main body, so that these parts do not cause thermal interference with each other and the performance of heat dissipation is improved to thereby extend the lifespan of the light tube.

To realize the above objectives, the present invention provides a structure of light tube, which comprises a main body, a power supply module, and at least one light emission element. The main body comprises a first heat dissipation zone, a second heat dissipation zone, and an accommodation chamber, which is located between the first heat dissipation zone and the second heat dissipation zone. The accommodation chamber receives and retains therein the power supply module, which comprises an enclosure and a power supply device. The enclosure forms a receiving space, in which the power supply device is received and retained. The main body has two ends respectively and electrically connected to two conductive terminals. The main body is coupled to a light emission element. Te light emission element dissipates heat therefrom directly through the main body, while the power supply dissipates heat through natural air flows without relying on the main body, so that these parts do not cause thermal interference with each other and the performance of heat dissipation is improved to thereby extend the lifespan of the light tube. Further, due to the modularized arrangements of the light emission element and the power supply, users are allowed to conduct maintenance and repairing operations by themselves with simple tools.

### BRIEF DESCRIPTION OF THE DRAWINGS

The present invention will be apparent to those skilled in the art by reading the following description of a preferred embodiment thereof with reference to the drawings, in which:

FIG. 1 is an exploded view of a light tube constructed in accordance with the present invention;

FIG. 2 is a perspective view of the light tube of the present invention in an assembled form;

FIG. 3 is a cross-sectional view of the light tube of the present invention;

FIG. 4 is another cross-sectional view of the light tube of the present invention.

### DETAILED DESCRIPTION OF THE PREFERRED EMBODIMENT

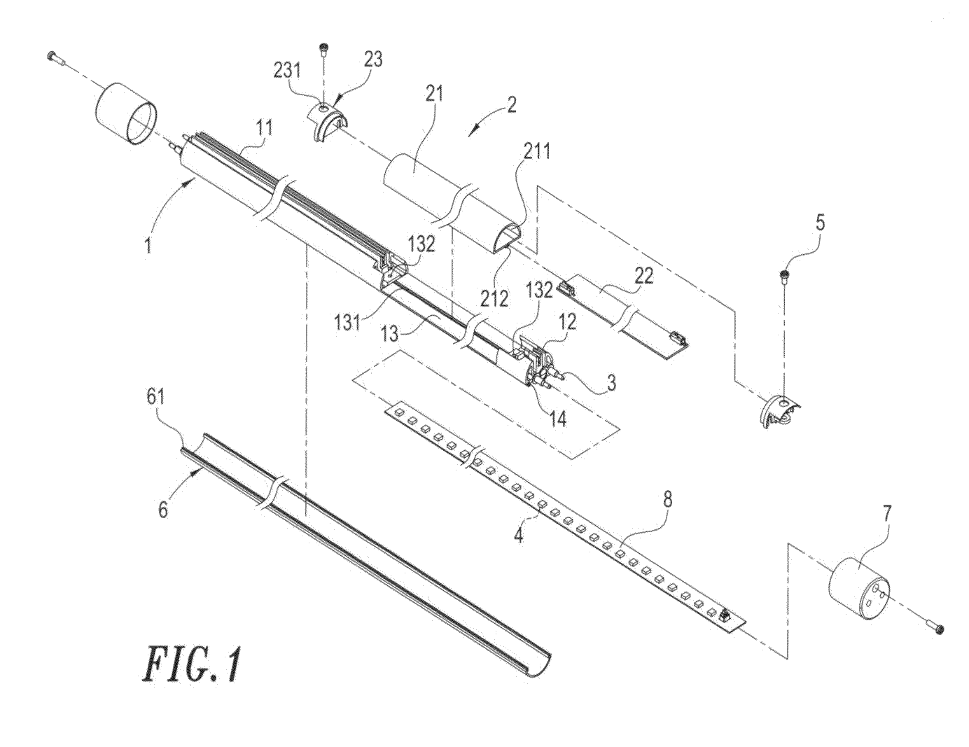

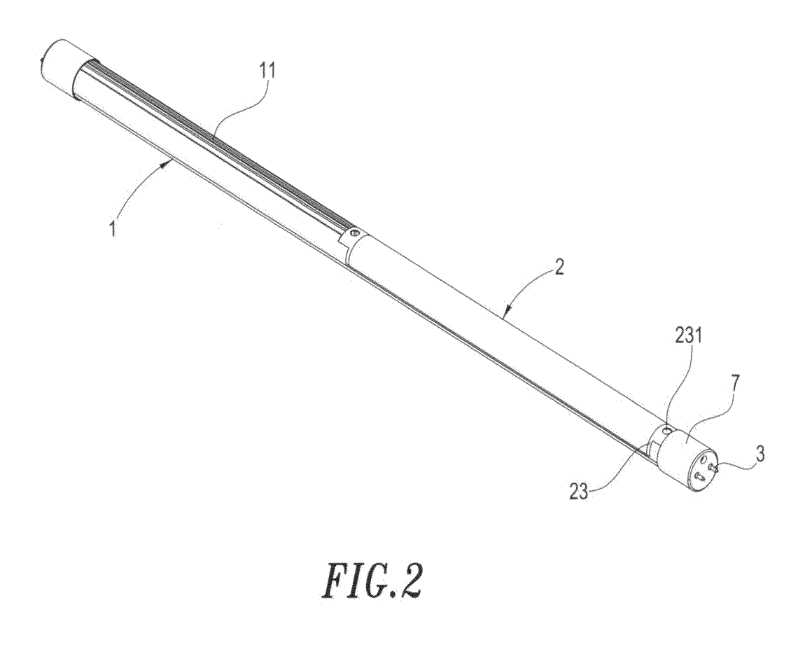

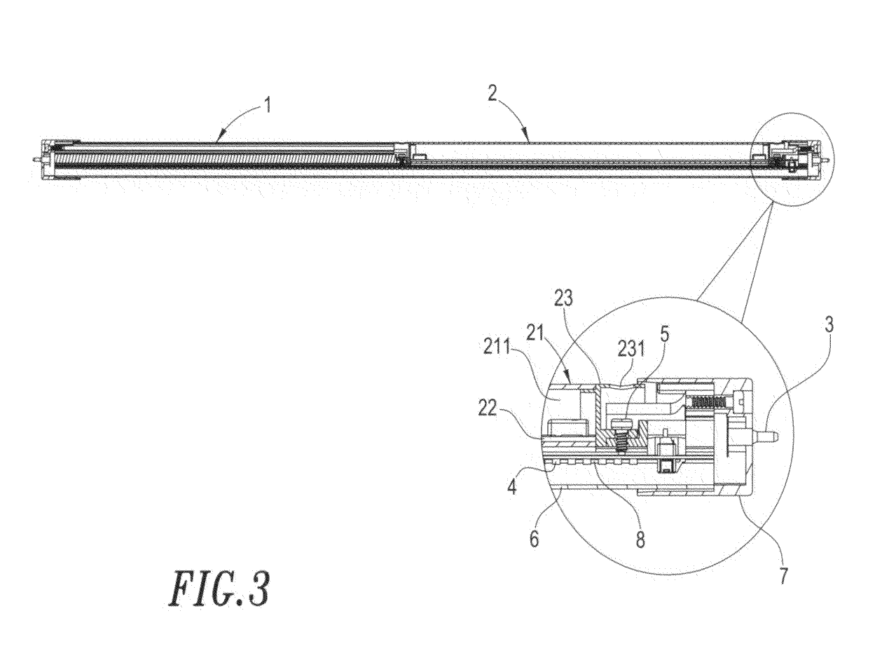

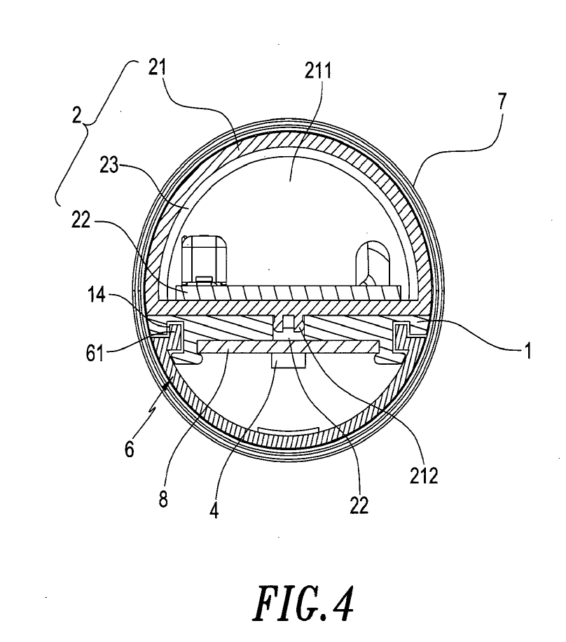

With reference to FIGS. 1-4, a structure of light tube according to the present invention comprises a main body, a power supply module, and at least one light emission element.

The main body 1 comprises a first heat dissipation zone 11, a second heat dissipation zone 12, and an accommodation chamber 13, which is located between the first heat dissipation zone 11 and the second heat dissipation zone 12. The accommodation chamber 13 receives and retains therein a power supply module 2, which comprises an enclosure 21 and a power supply device 22. The enclosure 21 forms a receiving space 211, in which the power supply device 22 is received and retained. The main body 1 has two ends that are respectively and electrically connected to two conductive terminals 3. The main body 1 is coupled to at least one light emission element 4. (In a practical example, a substrate 8 is additionally provided for coupling with and supporting the light emission element 4.)

The first heat dissipation zone 11 has an area greater than that of the second heat dissipation zone 12. The first heat dissipation zone 11 and the second heat dissipation zone 12 may comprise heat dissipation fins, whereby the light emission element 4 is allowed to dissipate heat therefrom directly through the heat dissipation fins. The light emission element 4 may comprise a light-emitting diode (LED). The main body 1 forms a groove 131 in a bottom of the accommodation chamber 13 and also forms mounting holes 132 in opposite ends of the groove 131. The power supply module 2 further comprises two end lids 23, which are respectively coupled to opposite ends of the enclosure 21. Each end lid 23 forms a hole 231 corresponding to a respective one of the mounting holes 132. The enclosure 21 has an underside forming a rib projection 212. To couple the power supply module 2 to the main body 1, the rib projection 212 is fit into the groove 131 of the accommodation chamber 13 and the fasteners 5 are set through the holes 231 to engage the mounting holes 132. The fasteners 5 may be screws or bolts.

Further, preferably, the light tube according to the present invention may comprise a cover 6 and two caps 7. Two track channels 14 are respectively formed along longitudinal edges of the main body 1 and the cover 6 has two top edges forming flanges 61 mateable with the track channels 14. To couple the cover 6 to the main body 1, the flanges 61 are fit into and slide along the track channels 14. The light emission element 4 is located between the main body 1 and the cover 6. The two caps 7 are respectively coupled to opposite ends of combined main body 1 and cover 6.

In summary, the structure of light tube according to the present invention has the following advantages:

Through modularized arrangement of the light emission element 4 and power supply 2, only a simple tool is needed in replacing these parts and thus maintenance and repairing can be easily done the users themselves. Through setting of the light emission element 4 and the power supply 2 at different locations, heat dissipation of the light emission element 4 is made directly through the main body 1, while heat from the power supply 2 is dissipated through natural air flows without relying on the main body 1, whereby both parts do not cause thermal interference with each other and the performance of heat dissipation is enhanced to thereby extend the lifespan of the light tube.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A light tube, comprising:
a main body, which comprises a first heat dissipation zone, a second heat dissipation zone, and a accommodation chamber located between the first heat dissipation zone and the second heat dissipation zone, the main body having two ends respectively and electrically connected to two conductive terminals;
a power supply module, which comprises an enclosure and a power supply device, the enclosure forming a receiving space, in which the power supply device is received and retained, the power supply module being received and retained in the accommodation chamber of the main body; and
at least one light emission element, which is coupled to the main body.

2. The light tube as claimed in claim 1, wherein the first heat dissipation zone has an area greater than the second heat dissipation zone.

3. The light tube as claimed in claim 1, wherein the first heat dissipation zone and the second heat dissipation zone comprise heat dissipation fins.

4. The light tube as claimed in claim 1, wherein the light emission element comprises a light-emitting diode.

5. The light tube as claimed in claim 1, wherein the enclosure of the power supply module is received and retained in the accommodation chamber.

6. The light tube as claimed in claim 5, wherein the main body forms a groove in a bottom of the accommodation chamber and mounting holes in opposite ends of the groove, the enclosure of the power supply module having an underside forming a rib projection, which is slidably receivable in the groove of the accommodation chamber.

7. The light tube as claimed in claim 1, wherein the power supply module comprises two end lids, which are respectively coupled to two ends of the enclosure, the end lids forming holes corresponding to the mounting holes of the main body, whereby the power supply module is fixed to the main body through fasteners put through the holes and the mounting holes.

8. The light tube as claimed in claim 7, wherein the fasteners comprise bolts.

9. The light tube as claimed in claim 1 further comprising a cover and two caps, the cover being coupled to the main body, the light emission element being located between the main body and the cover, the two caps being coupled to ends of a combined assembly of the main body and the cover.

10. The light tube as claimed in claim 1 further comprising a substrate, which is coupled to and supports the light emission element.
